(19) United States
(12) Patent Application Publication
(10) Pub. No.: US 2023/0080660 A1
(43) Pub. Date: Mar. 16, 2023

(54) SYSTEMS AND METHOD FOR VISUAL-AUDIO PROCESSING FOR REAL-TIME FEEDBACK

(71) Applicant: Kalyna Miletic, Mississauga (CA)

(72) Inventor: Kalyna Miletic, Mississauga (CA)

(21) Appl. No.: 17/902,132

(22) Filed: Sep. 2, 2022

Related U.S. Application Data
(60) Provisional application No. 63/241,264, filed on Sep. 7, 2021.

(51) Int. Cl. G06V 20/40; G06V 40/16; G06V 40/20; G06V 10/70; G10L 25/63; G10L 25/57; G10L 15/22; G10L 15/06

(52) U.S. Cl. CPC G06V 20/41; G06V 40/172; G06V 40/20; G06V 10/70; G10L 25/63; G10L 25/57; G10L 15/22; G10L 15/063; G10L 2015/228; G10L 2015/225

(57) ABSTRACT

Embodiments of the present disclosure provide for using an ensemble of trained machine learning algorithms to perform facial detection, audio analysis, and keyword modeling for video meetings/calls between two more user. The ensemble of trained machine learning models can process the video to divide the video into video, audio, and text components, which can be provided as inputs to the machine learning models. The outputs of the trained machine learning models can be used to generate responsive feedback that is relevant to topic of the meeting/call and/or to the engagement and emotional state of the user(s).

### RELATED APPLICATION

The present application claims priority to and the benefit of U.S. Provisional Application No. 63/241,264, filed on Sep. 7, 2022, the disclosure of which is incorporated by reference herein in its entirety.

### BACKGROUND

Our interactions with each other have transitioned from primarily face-to-face interactions to a hybrid of in-person and online interactions. In a “hybrid” world of in-person and online interactions, our ability to communicate with each other can be enhanced by technology.

### BRIEF DESCRIPTION OF THE DRAWINGS

FIG. 1 illustrates an example computing environment for implementing a system for visual-audio-text processing for real-time feedback in accordance with embodiments of the present disclosure.

FIG. 2 is a block diagram of an exemplary server in accordance with embodiments of the present disclosure.

FIG. 3 is a block diagram of an exemplary client computing device in accordance with embodiments of the present disclosure.

FIG. 4 is a flowchart illustrating an example process for visual-audio processing and providing real-time feedback in accordance with embodiments of the present disclosure.

FIG. 5 is a flowchart illustrating an overall system in which video data is processed to be inputs to trained machine learning models in accordance with embodiments of the present disclosure.

FIG. 6 is a flowchart illustrating training and deployment of a machine learning model that detects the facial expressions of a person via video camera and returns a prediction of the engagement state back onto the screen through notification in accordance with embodiments of the present disclosure.

FIG. 7 is a flowchart illustrating training and deployment of a machine learning model that extracts audio features from and predicts emotional states in accordance with embodiments of the present disclosure.

FIG. 8 is a flowchart illustrating training and deployment of machine learning models for keyword detection in transcribed audio in accordance with embodiments of the present disclosure.

FIG. 9 is a flowchart illustrating training and deployment of an ensemble of machine learning models to real-time feedback in accordance with embodiments of the present disclosure.

FIGS. 10-11 illustrate graphical user interfaces in accordance with embodiments of the present disclosure.

FIG. 12-14 illustrate an example of real-time dynamic feedback for users based on trained machine learning models in accordance with embodiments of the present disclosure.

### DETAILED DESCRIPTION

Embodiments of the present disclosure include systems, methods, and non-transitory computer-readable to train machine learning models and execute trained machine learning models for video detection and recognition and audio/speech detection and recognition. The outputs of the trained machine learning models can be used to dynamically provide real-time feedback and recommendations to users during user interactions that is specific to the user interactions and the context of the user interactions. In a non-limiting example application, embodiments of the present disclosure can improve the effectiveness and efficiency of meetings (in-person or online) by providing the host and participants in meetings real time feedback and insights so that they are equipped to manage the meeting better depending on the desired meeting goal or desired outcome. In this regard, the real-time feedback can facilitate skill development during the online or in person meetings. As an example, embodiments of the present disclosure can help individuals develop confidence, public speaking skills, empathy, courage, sales skills and so on. Embodiments of the present disclosure can be used in business environments, teaching environments, any relationship with two people where audio, text and/or video is involved and where audio, text or video is captured, which can be processed by embodiments of the present disclosure for emotions, body language cues, keywords/themes/verbal tendencies and then output feedback.

Embodiments of the present disclosure can implement facial recognition to determine body language and engagement of the users and/or can implement audio analysis to determine context (e.g., themes and keywords) and emotions of the users with the trained machine learning models, which can be utilized by the machine learning models to generate feedback that can be rendered on the users' displays during the meeting. For example, embodiments of the present disclosure can provide feedback based on data gathered during meetings including but not limited to audio, video, chat, and user details. Trained machine learning models can use data from the meeting and audio/video files to analyze body language, tone of voice, eye movements, hand gestures, speech and interaction frequency to understand key emotions (happiness, sadness, disgust, stress, anxiety, neutral, anger), engagement, motivation, positivity toward an idea/willingness to adopt an idea, and more. The trained machine learning models can analyze users' tendencies in real time, gather a baseline for each user, and then provide insights that would move them in a more effective and/or efficient direction to produce more of their desired result.

In a non-limiting example application, embodiments of the present disclosure can train and deploy an ensemble of machine learning models that analyze whole or snippets of video and audio data from online or in-person meetings. Embodiments of the present disclosure can include delivery of video files (batch or live/streamed), video analysis through the use of three trained models—level of engagement, 7-emotion detection and keyword analysis and delivery of the model outputs.

In a non-limiting example application, a manager can run a goal setting session with a colleague, where the manager wants to know if the colleague buys into/agrees with the proposed goals and understand the reception of each main idea. Through a graphical user interface, the manager can select an option “goal setting meeting” as the context of the meeting. During the meeting, embodiments of the present disclosure can analyze facial expressions, words used by both parties, tone of voice, and can dynamically generate context specific insights to optimize the meeting based on the specific context for why the meeting is being held (e.g., “goal setting meeting”). Some non-limiting example scenarios within which the embodiments of the present disclosure can be implemented include the following:
One on One Meetings
Team Standup Meetings
Team Update Meetings/Progress Review
Goal Setting Meetings
Personal Development (Individual records themselves to practice a speech/presentation/video on camera)
Teacher/Student classes or meetings
Doctor/Nurse/Patient meetings
Presentations
Interviews
Brainstorming
Client Meetings/Sales Calls
Call Center/Help Center Calls
Social get-togethers/online parties/watch parties where people watch the same movie/show
Other contexts where individuals gather and it would be beneficial to understand the reception of ideas from all parties, understand motivations/emotional states/willingness to adopt ideas/projects.

In accordance with embodiments of the present disclosure, systems, methods, and non-transitory computer-readable media are disclosed. The non-transitory computer-readable media can store instructions. One or more processors can be programmed to execute the instructions to implement a method that includes training a plurality of machine learning models for facial recognition, text analysis, and audio analysis; receiving visual-audio data and text data (if available) corresponding to a video meeting or call between users; separating the visual-audio data into video data and audio data; executing a first trained machine learning model of the plurality of trained machine learning models to implement facial recognition to determine body language and engagement of at least a first one of the users; executing at least a second trained machine learning model of the plurality of trained machine learning models to implement audio analysis to determine context of the video meeting or call and emotions of at least the first one of the users; and autonomously generating feedback based on one or more outputs of the first and second trained machine learning models, the feedback being rendered in a graphical user interface of at least one of the first one of the users or a second one of the users during the meeting. The audio analyze can include an analysis of the vocal characteristics of the users (e.g., pitch, tone, and amplitude) and/or can analyze the actual words used by the users. As an example, the analysis can monitor the audio data for changes in the vocal characteristics which can be processed the second machine learning algorithm to determine emotions of the caller independent to or in conjunction with the facial analysis performed by the first trained machine learning model. As another example, the analysis can convert the audio data to text data using a speech-to-text function and natural language processing and the second trained machine learning model or a trained third machine learning model can analysis the text to determine context of the video meeting or call and emotions of at least the first one of the users.

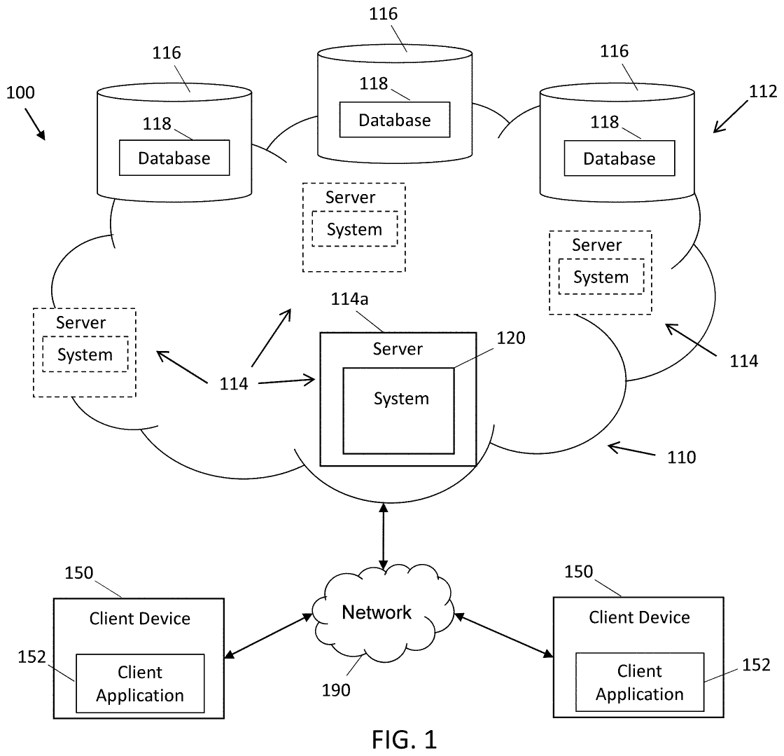

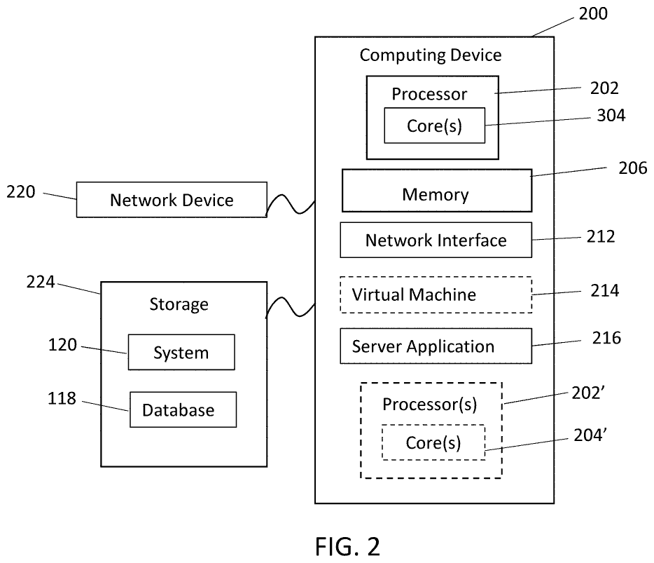

FIG. 1 illustrates an example computing environment 100 for implementing visual-audio processing for real-time feedback in accordance with embodiments of the present disclosure. As shown in FIG. 1, the environment 100 can include distributed computing system 110 including shared computer resources 112, such as servers 114 and (durable) data storage devices 116, which can be operatively coupled to each other. For example, two or more of the shared computer resources 112 can be directly connected to each other or can be connected to each other through one or more other network devices, such as switches, routers, hubs, and the like. Each of the servers 114 can include at least one processing device (e.g., a central processing unit, a graphical processing unit, etc.) and each of the data storage devices 116 can include non-volatile memory for storing databases 118. The databases 118 can store data including, for example, video data, audio data, text data, training data for training machine learning models, test/validation data for testing trained machine learning models, parameters for trained machine learning models, outputs of machine learning models, and/or any other data that can be used for implementing embodiments of the system 120. An exemplary server is depicted in FIG. 2.

Any one of the servers 114 can implement instances of a system 120 for implementing visual-audio processing for real-time feedback and/or the components thereof. In some embodiments, one or more of the servers 114 can be a dedicated computer resource for implementing the system 120 and/or components thereof. In some embodiments, one or more of the servers 114 can be dynamically grouped to collectively implement embodiments of the system 120 and/or components thereof. In some embodiments, one or more servers 114 can dynamically implement different instances of the system 120 and/or components thereof.

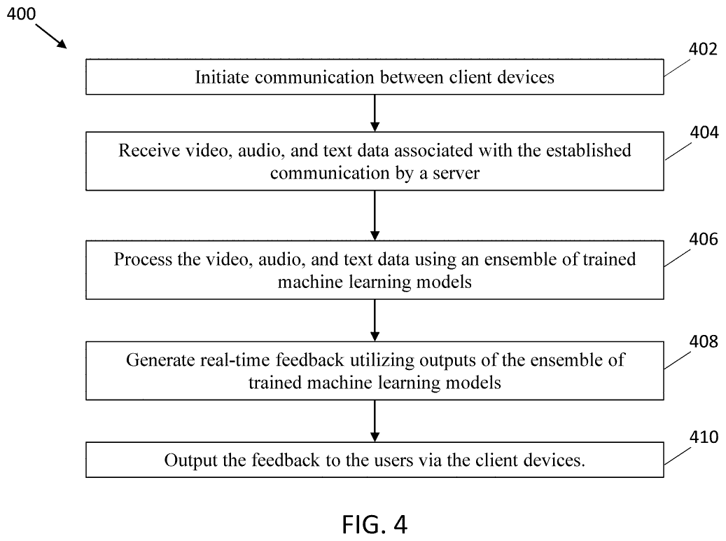

The distributed computing system 110 can facilitate a multi-user, multi-tenant environment that can be accessed concurrently and/or asynchronously by client devices 150. For example, the client devices 150 can be operatively coupled to one or more of the servers 114 and/or the data storage devices 116 via a communication network 190, which can be the Internet, a wide area network (WAN), local area network (LAN), and/or other suitable communication network. The client devices 150 can execute client-side applications 152 to access the distributed computing system 110 via the communications network 190. The client-side application(s) 152 can include, for example, a web browser and/or a specific application for accessing and interacting with the system 120. In some embodiments, the client side application(s) 152 can be a component of the system 120 that is downloaded and installed on the client devices (e.g., an application or a mobile application). In some embodiments, a web application can be accessed via a web browser. In some embodiments, the system 120 can utilize one or more application-program interfaces (APIs) to interface with the client applications or web applications so that the system 120 can receive video and audio data and can provide feedback based on the video and audio data. In some embodiments, the system 120 can include an add-on or plugin that can be installed and/or integrated with the client-side or web applications. Some non-limiting examples of client-side or web applications can include but are not limited to Zoom, Microsoft Teams, Skype, Google Meet, WebEx, and the like. In some embodiments, the system 120 can provide a dedicate client-side application that can facilitate a communication session between multiple client devices as well as to facilitate communication with the servers 114. An exemplary client device is depicted in FIG. 4.

In exemplary embodiments, the client devices 150 can initiate communication with the distributed computing system 110 via the client-side applications 152 to establish communication sessions with the distributed computing system 110 that allows each of the client devices 150 to utilize the system 120, as described herein. For example, in response to the client device 150a accessing the distributed computing system 110, the server 114a can launch an instance of the system 120. In embodiments which utilize multi-tenancy, if an instance of the system 120 has already been launched, the instance of the system 120 can process multiple users simultaneously. The server 114a can execute instances of each of the components of the system 120 according to embodiments described herein.

In an example operation, user can communicate with each other via the client applications 152 on the client devices 150. The communication can include video, audio, and/or text being transmitted between the client devices 150. The system 120 executed by the servers 114 can also receive video, audio, and/or text data. The system 120 executed by the servers 114 implement facial recognition to determine body language and engagement of the users and/or can implement audio analysis and/or text analysis to determine context (e.g., themes and keywords) and emotions of the users with the trained machine learning models, which can be utilized by the machine learning models to generate feedback that can be rendered on the displays of the client devices during the meeting. For example, the system can be executed by the server to provide feedback based on data gathered during meetings including but not limited to audio, video, chat (e.g., text), and user details. Trained machine learning models can use data from the meeting and audio/video files to analyze body language, tone of voice, eye movements, hand gestures, speech, text, and interaction frequency to understand key emotions (happiness, sadness, disgust, stress, anxiety, neutral, anger), engagement, motivation, positivity toward an idea/willingness to adopt an idea, and more. The trained machine learning models can analyze users' tendencies in real time, gather a baseline for each user, and then provide insights that would move them in a more effective and/or efficient direction to produce more of their desired result.

The system 120 executed by the servers 114 can also receive video, audio, and text data of users as well as additional user data and can use the received video, audio, and text data to train the machine learning models. The video, audio, text, and additional user data can be used by system 120 executed by the servers 114 to map trends based on different use cases (e.g., contexts of situations) and demographics (e.g., a 42 year old male sales manager from Japan working at an automobile company compared to a 24 year old female sales representative from Mexico working at a software company). The industry trends based on the data collected can be used by the system 120 to showcase industry standards of metrics and to cross-culturally understand tendencies as well. The aggregation and analysis of data to identify trends based on one or more dimensions/parameters in the data can be utilized by the system 120 to generate the dynamic feedback to users as a coaching model via the trained machine learning models. As an example, if a sales representative in Japan exhibits low stress and 42% speaking time in a sales call, and he is a top producer (e.g., identified as a top 10% sales representative in calls), the machine learning models can learn (be trained) from his tendencies, and funnel feedback to other users based on his tendencies/markers (e.g., if a user is approaching speaking 42% of the time during a call, the system 120 can automatically send the user a notification to help them listen more based on a dynamic output of the machine learning models). Embodiments of the system 120 can help people to lead by example because the machine learning models can be trained to take the best leader's tendencies into account and then funnel those tendencies to more junior/less experienced people in the same role, automating the development process. The system 120 can use any data collected across industries, gender, location, age, role or company and cross referenced this data with the emotion, body language, facial expression, and/or words being used during a call or meeting to generate context specific and tailored feedback to the users.

FIG. 2 is a block diagram of an exemplary computing device 200 for implementing one or more of the servers 114 in accordance with embodiments of the present disclosure. In the present embodiment, the computing device 200 is configured as a server that is programmed and/or configured to execute one of more of the operations and/or functions for embodiments of the system 120 and to facilitate communication with the client devices described herein (e.g., client device(s) 150). The computing device 200 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more solid state drives), and the like. For example, memory 206 included in the computing device 200 can store computer-readable and computer-executable instructions or software for implementing exemplary embodiments of the components/modules of the system 120 or portions thereof, for example, by the servers 114. The computing device 200 also includes configurable and/or programmable processor 202 and associated core 204, and optionally, one or more additional configurable and/or programmable processor(s) 202′ (e.g., central processing unit, graphical processing unit, etc.) and associated core(s) 204′ (for example, in the case of computer systems having multiple processors/cores), for executing computer-readable and computer-executable instructions or software stored in the memory 206 and other programs for controlling system hardware. Processor 202 and processor(s) 202′ may each be a single core processor or multiple core (204 and 204′) processor.

Virtualization may be employed in the computing device 200 so that infrastructure and resources in the computing device may be shared dynamically. One or more virtual machines 214 may be provided to handle a process running on multiple processors so that the process appears to be using only one computing resource rather than multiple computing resources. Multiple virtual machines may also be used with one processor.

Memory 206 may include a computer system memory or random access memory, such as DRAM, SRAM, EDO RAM, and the like. Memory 206 may include other types of memory as well, or combinations thereof.

The computing device 200 may include or be operatively coupled to one or more data storage devices 224, such as a hard-drive, CD-ROM, mass storage flash drive, or other computer readable media, for storing data and computer-readable instructions and/or software that can be executed by the processing device 202 to implement exemplary embodiments of the components/modules described herein with reference to the servers 114.

The computing device 200 can include a network interface 212 configured to interface via one or more network devices 220 with one or more networks, for example, a Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections (including via cellular base stations), controller area network (CAN), or some combination of any or all of the above. The network interface 212 may include a built-in network adapter, network interface card, PCMCIA network card, card bus network adapter, wireless network adapter, USB network adapter, modem or any other device suitable for interfacing the computing device 200 to any type of network capable of communication and performing the operations described herein. While the computing device 200 depicted in FIG. 2 is implemented as a server, exemplary embodiments of the computing device 200 can be any computer system, such as a workstation, desktop computer or other form of computing or telecommunications device that is capable of communication with other devices either by wireless communication or wired communication and that has sufficient processor power and memory capacity to perform the operations described herein.

The computing device 200 may run any server operating system or application 216, such as any of the versions of server applications including any Unix-based server applications, Linux-based server application, any proprietary server applications, or any other server applications capable of running on the computing device 200 and performing the operations described herein. An example of a server application that can run on the computing device includes the Apache server application.

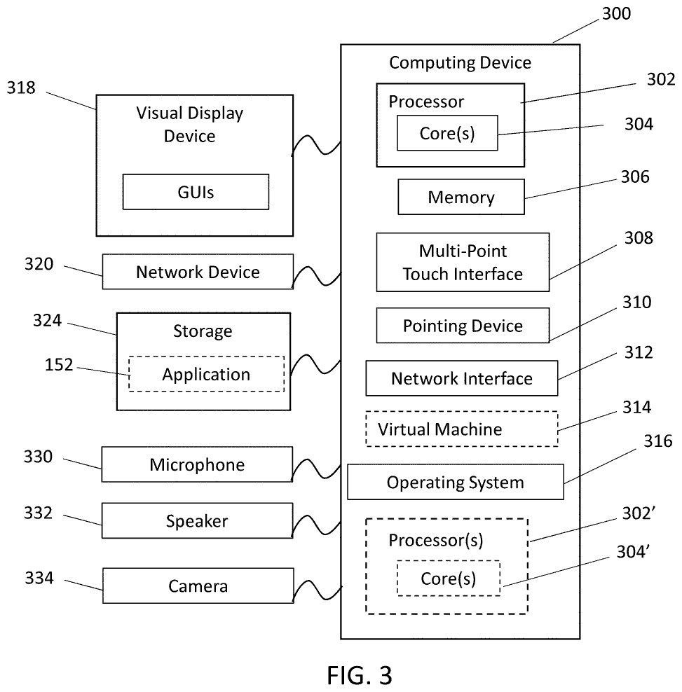

FIG. 3 is a block diagram of an exemplary computing device 300 for implementing one or more of the client devices (e.g., client devices 150) in accordance with embodiments of the present disclosure. In the present embodiment, the computing device 300 is configured as a client-side device that is programmed and/or configured to execute one of more of the operations and/or functions for embodiments of the client-side applications 152 and to facilitate communication with each other and/or with the servers described herein (e.g., servers 114). The computing device 300 includes one or more non-transitory computer-readable media for storing one or more computer-executable instructions or software for implementing exemplary embodiments of the application described herein (e.g., embodiments of the client-side applications 152, the system 120, or components thereof). The non-transitory computer-readable media may include, but are not limited to, one or more types of hardware memory, non-transitory tangible media (for example, one or more magnetic storage disks, one or more optical disks, one or more solid state drives), and the like. For example, memory 306 included in the computing device 300 may store computer-readable and computer-executable instructions, code or software for implementing exemplary embodiments of the client-side applications 152 or portions thereof. In some embodiments, the client-side applications 152 can include one or more components of the system 120 such that the system is distributed between the client devices and the servers 114. In some embodiments, the client-side application can interface with the system 120, where the components of the system 120 reside on and are executed by the servers 114.

The computing device 300 also includes configurable and/or programmable processor 302 (e.g., central processing unit, graphical processing unit, etc.) and associated core 304, and optionally, one or more additional configurable and/or programmable processor(s) 302′ and associated core(s) 304′ (for example, in the case of computer systems having multiple processors/cores), for executing computer-readable and computer-executable instructions, code, or software stored in the memory 306 and other programs for controlling system hardware. Processor 302 and processor(s) 302′ may each be a single core processor or multiple core (304 and 304′) processor.

Virtualization may be employed in the computing device 300 so that infrastructure and resources in the computing device may be shared dynamically. A virtual machine 314 may be provided to handle a process running on multiple processors so that the process appears to be using only one computing resource rather than multiple computing resources. Multiple virtual machines may also be used with one processor.

Memory 306 may include a computer system memory or random access memory, such as DRAM, SRAM, MRAM, EDO RAM, and the like. Memory 306 may include other types of memory as well, or combinations thereof.

A user may interact with the computing device 300 through a visual display device 318, such as a computer monitor, which may be operatively coupled, indirectly or directly, to the computing device 300 to display one or more of graphical user interfaces of the system 120 that can be provided by or accessed through the client-side applications 152 in accordance with exemplary embodiments. The computing device 300 may include other I/O devices for receiving input from a user, for example, a keyboard or any suitable multi-point touch interface 308, and a pointing device 310 (e.g., a mouse). The keyboard 308 and the pointing device 310 may be coupled to the visual display device 318. The computing device 300 may include other suitable I/O peripherals. As an example, the computing device 300 can include one or more microphones 330 to capture audio, one or more speakers 332 to output audio, and/or one or more cameras 334 to capture video.

The computing device 300 may also include or be operatively coupled to one or more storage devices 324, such as a hard-drive, CD-ROM, or other computer readable media, for storing data and computer-readable instructions, executable code and/or software that implement exemplary embodiments of the client-side applications 152 and/or the system 120 or portions thereof as well as associated processes described herein.

The computing device 300 can include a network interface 312 configured to interface via one or more network devices 320 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. The network interface 312 may include a built-in network adapter, network interface card, PCMCIA network card, card bus network adapter, wireless network adapter, USB network adapter, modem or any other device suitable for interfacing the computing device 300 to any type of network capable of communication and performing the operations described herein. Moreover, the computing device 300 may be any computer system, such as a workstation, desktop computer, server, laptop, handheld computer, tablet computer (e.g., the iPad™ tablet computer), mobile computing or communication device (e.g., a smart phone, such as the iPhone™ communication device or Android communication device), wearable devices (e.g., smart watches), internal corporate devices, video/conference phones, smart televisions, video recorder/camera, or other form of computing or telecommunications device that is capable of communication and that has sufficient processor power and memory capacity to perform the processes and/or operations described herein.

The computing device 300 may run any operating system 316, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the processes and/or operations described herein. In exemplary embodiments, the operating system 316 may be run in native mode or emulated mode. In an exemplary embodiment, the operating system 316 may be run on one or more cloud machine instances.

FIG. 4 is a flowchart illustrating an example process 400 for visual-audio-text processing and providing real-time feedback via an embodiment of the system 120. At operation 402, a first client device operated by a first user initiates communication with a second client device operated by a second user via a client application (e.g., a web-based application accessed via a web browser or a specific client-side application for initiating communication). In some embodiments, a single client device can be used when the meeting is in person. As an example, one or more cameras and/or microphones can be operatively coupled to the client device and capture video and audio data of multiple users in a room together. At operation 404, the video, audio, and text data associated with the established communication can be received by one or more servers (e.g., servers 114) which can execute an embodiment the system 120 at step 406 to process the video, audio, and text data using an ensemble of trained machine learning models. As an example, the system 120 can be executed by the server to implement a trained facial recognition machine learning model to detect and identify facial expressions and/or body language of the users communicating with each other via the cameras (e.g., cameras 334), microphones (e.g., microphones 332), and speakers (e.g., speakers 330) of client devices. As another example, the system 120 can be executed by the server to implement a trained audio recognition machine learning model to detect and identify the tone and/or emotional state of the users. As another example, the system 120 can be executed by the server to implement a trained machine learning model to facilitate speech-to-text transcription and detect and identify key words that can be used to determine a context of the communication and/or to be used in combination with the machine learning models for processing the video and/or audio data. As another example, the system 120 can be executed by the server to implement a trained machine learning model to detect and identify key words from text data entered by the users (e.g., via keyboard 308) that can be used to determine a context of the communication and/or to be used in combination with the machine learning models for processing the video and/or audio data. At step 408, the system 120 executed by the server can utilize outputs of the ensemble of trained machine learning models to generate real-time feedback that can be transmitted to the client device(s) during the established communication between the client devices. At step 410, the client device can output the feedback to the users, for example, via the displays and/or speakers of the client devices.

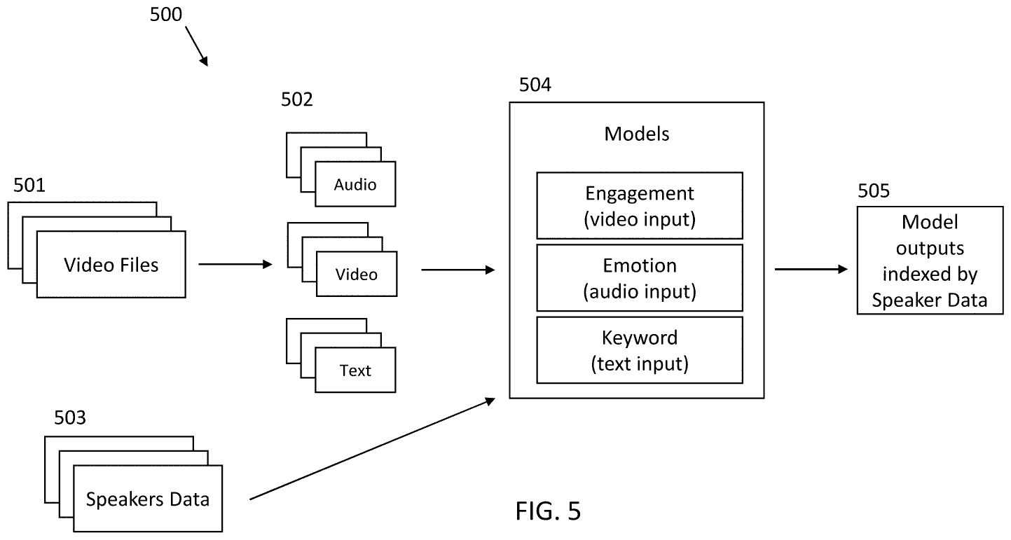

FIG. 5 is a flowchart illustrating the overall system process 500 of an embodiment of the system 120 in which video data is processed to be inputs to trained machine learning models in accordance with embodiments of the present disclosure. During and/or after an online or in-person meeting or video call, video, audio, and text data can be received by embodiments of the system 120. The video data can be received as a stream of data by the system 120 and/or can be received as video files (501). The video data can be processed or decomposed into audio, video, and text components (502). An additional text component can be received corresponding text entered by users via a graphical user interface (e.g., a chat window). The audio, video, and text components can be used as inputs to machine learning models. The audio component can be extracted into an audio file, such as a .wav file or other audio file format, and can be used by machine learning models for detecting emotion and keywords. Additionally, the speaker's data (speech data from the users) from the audio component can be used to determine a context of the online meeting or video call (503). The system 120 can transcribe the audio file for the emotion and keyword machine learning models. As a non-limiting example, the system 120 can use Mozilla's speech transcriber to generate textual data from the audio component, which can be used by the emotion and keywords machine learning models including, for example, natural language processing. Natural language processing can be used analyze the transcribed audio and/or user-entered text to analyze the text to determine trends in language from the text. As a non-limiting example, dlib's face detection model for video component, which can be an input to a machine learning model to detect engagement of a user (e.g., an engagement model). Once the audio, video, and text components are run through the machine learning models (504), the machine learning models outputs a report indexed by the speaker's data (505). The system can also extract data on each speaker/user that is delivered through the titles of the video files.

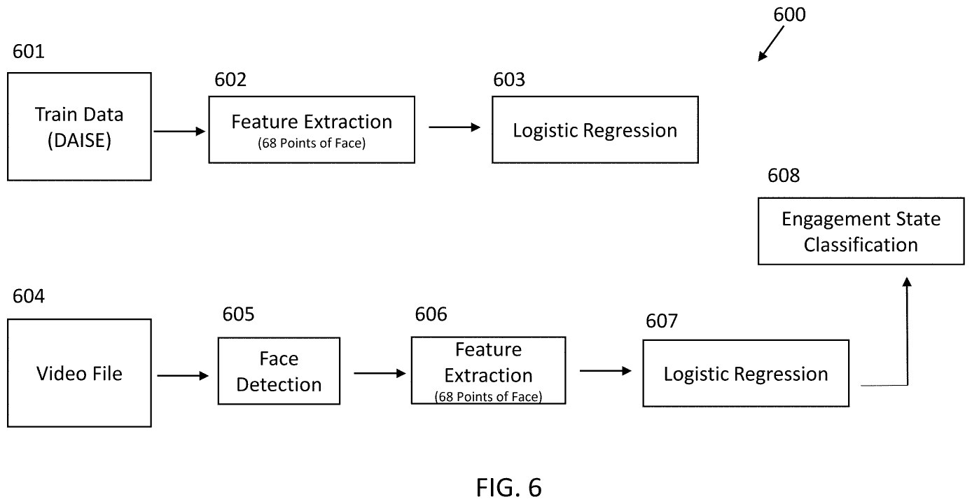

FIG. 6 is a flowchart illustrating training and deployment (600) of a machine learning model (an engagement model) of an embodiment of the system 120 that that uses a face detector model and a linear regression model. The engagement model of the system 120 can detect the facial expressions of a user via video camera during a video meeting/call and can return a prediction of the engagement state as a notification that can be rendered on a display of the client device associated with the user or a different client device associated with another user (e.g., another user participating or hosting the video meeting/call). The face detector model can detect the facial expressions of a person via images captured by one or more video cameras and returns a prediction of the engagement state back onto the screen through notification in accordance with embodiments of the present disclosure.

First, a logistic regression model can be trained on a labelled dataset (601). As a non-limiting example, a labelled dataset that can be used as training data can be found at iith.ac.in/˜daisee-dataset/. A face detector model can detect faces in training data corresponding to videos of faces (602). The outputs of the face detector model can be used as features for a trained logistic regression model (603) that detects if a speaker is engaged or not. The dataset contains labelled video snippets of people (604) in four states: boredom, confusion, engagement, and frustration. Lastly, the face detector model (605) can be used to create a number of features (e.g., 68 features) (606) in order to train the logistic regression model to detect if the video participant is in the “engagement” state or not (608).

As a non-limiting example, in some embodiments, OpenCV can be used by the system 120 to capture and return altered real-time video streamed through the camera of a user. The emotion model of the system 120 can be built around OpenCV's Haar Cascade face detector, and can be used to detect faces in each frame of a video. OpenCV's classifies Cascade tandem with the Haar Cascade data prior to returning video, and can be used to detect faces in a video stream. For example, OpenCV's CascadeClassifier( ) function can be called in tandem with the Haar Cascade data prior to returning video, and is used to detect faces in a video stream. Using OpenCV, the system 120 can display a preview of the video onto a display of the client device(s) for users to track returning information being output by the emotion model. The DeepFace library can be called by the system 120 and used to analyze the video, frame per frame, and output a prediction of the emotion. Using OpenCV, the system can take each frame and convert it into greyscale. Using OpenCV, the system 120 can take the variable stored in the grey conversion, and detect Multi Scale (e.g., using the uses the detectMultiScale( ) function) in tandem with information previously gathered to detect faces. When the above is completed, using OpenCV, the system 120 can then take each value and return an altered image as video preview. For each frame, the system 120 can use OpenCV to draw a rectangle around the face of the meeting/call participant and return that as the video preview. Using OpenCV, the system 120 can then also input text beside the rectangle, with a prediction of which engagement state the user captured in the video is conveying at a certain moment in time, e.g., at a certain frame or set of frames (happy, sad, angry, bored, engaged, confused, etc.).

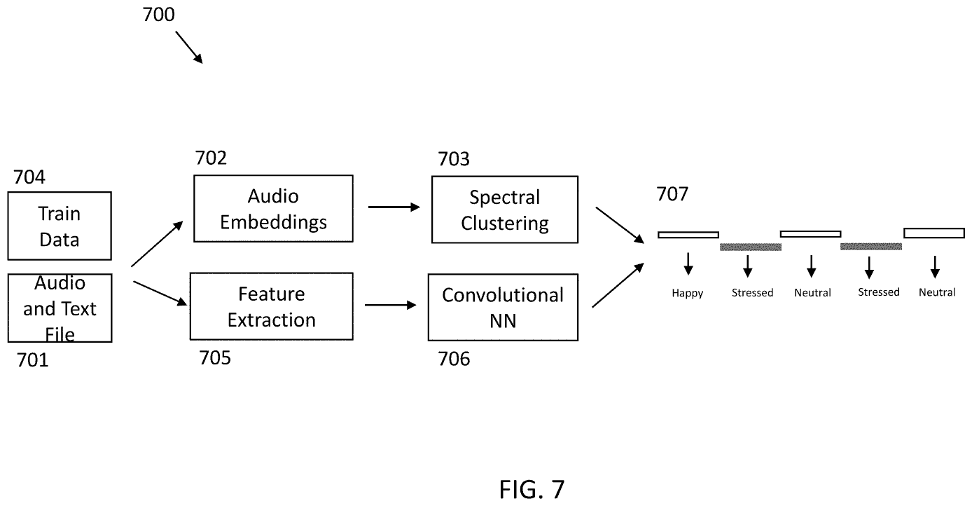

FIG. 7 is a flowchart illustrating training and deployment (700) of a machine learning model in an embodiment of the system 120 that extracts audio features from and predicts emotional states in accordance with embodiments of the present disclosure (e.g., an emotion model). The audio components from training data can contain at least two speakers and the system 120 must determine who is speaking at each timestep in the audio component. To determine who is speaking, the system 120 can use a speaker diarization process. In this process, the audio component of the video meeting/call (701) can be processed one time step at a time and audio embeddings are generated for the timesteps (702). The system 120 can use a voice-activity detector to trim out silences in the audio component and normalize the decibel level prior to generating the audio embeddings. The audio embeddings can be extracted by the system 120 using, for example, Resemblyzer's implementation of this technique by Google. The system 120 can use spectral clustering on the generated audio embeddings (703) to determine a “voiceprint” of each speaker. This voiceprint can be compared to the audio embeddings of each time step to determine which speaker is speaking. As a non-limiting example, the system 120 can identify the first detected speaker to be the coach/host of the video meeting/call.

Three groups of audio features (705) can be extracted from the audio component in the training data (704). These audio features can be Chroma stft, MFCC and MelSpectogram. The system 120 can also apply two data augmentation techniques—noise and stretch and pitch to generalize the machine learning models. This can result in a tripling of the training examples. A convolutional neural net can be trained (706) on labelled and publicly available datasets. As a non-limiting example, one or more of the following dataset can be used to train the convolutional neural net:
smartlaboratory.org/ravdess/;
github.com/CheyneyComputerScience/CREMA-D;
tspace.library.utoronto.ca/handle/1807/24487; and/or
tensorflow.org/datasets/catalog/savee.

These datasets contain audio files that are labelled with 7 types of emotions: ‘Stressed’, “Anxiety”, “Disgust”, “Happy”, “Neutral”, “Sad”, and “Surprised” (707).

The emotion with the highest propensity based on the output of the convolution neural net can be the emotion predicted for each timestep and can be associated with a specific speaker based on an output of the spectral clustering for each respective timestep. The emotion with the most number of timesteps detected throughout the audio component for a speaker can be associated with the emotion of the speaker for the whole audio component. In some embodiments, The top two emotions with the highest propensity can be output by the emotion model.

The emotion model can be dockerized and a docker image can be built. This can be done by the system 120 through a dockerfile which is a text file that has instructions to build image. A docker image is a template that creates container which is a convenient way to package up an application and its preconfigured server environments. Once the dockerization is successful, the docker image can be hosted be servers (e.g., servers 114), and the dockerized model can be called periodically to process the audio component at a set number of minutes and provide feedback to user.

Some example scenarios can include interviews, medical checkups, educational settings, and/or any other scenarios in which a video meeting/call is being conducted.

### Example Interview Scenario

Interviewer will receive analysis regarding the interviewee's emotion every set number of minutes. This will correspond directly to specific questions that the interviewer asks. Example: Question asked by interviewer: “Why did you choose our company?” In the next 2-3 minutes it takes the interviewee to answer the question, the interviewer will receive a categorization that describes the emotion of the interviewee while answering this question. In this case, the emotion could be “Stressed.”

### Example Medical Checkup Scenario

Doctor lets patient know the status of their medical condition (ie lung tumor). Through the patient's response, doctor is able to find out what emotions the patient is feeling, and converses with patient accordingly. In this case, the patient could me feeling a multitude of emotions, so model gives a breakdown percentage of the top 2 emotions. In this case, it could be 50% “Surprised” and 30% “Stressed”.

### Educational Settings Scenario

Teacher is explaining concept to students. Besides receiving feedback on the students' emotions, the teacher itself can receive a categorization of the emotion they are projecting. During her lecture, the teacher gets a report that she has been majorly “Neutral.” Using this piece of information, the teacher then bumps up her enthusiasm level to engage her students in the topic.

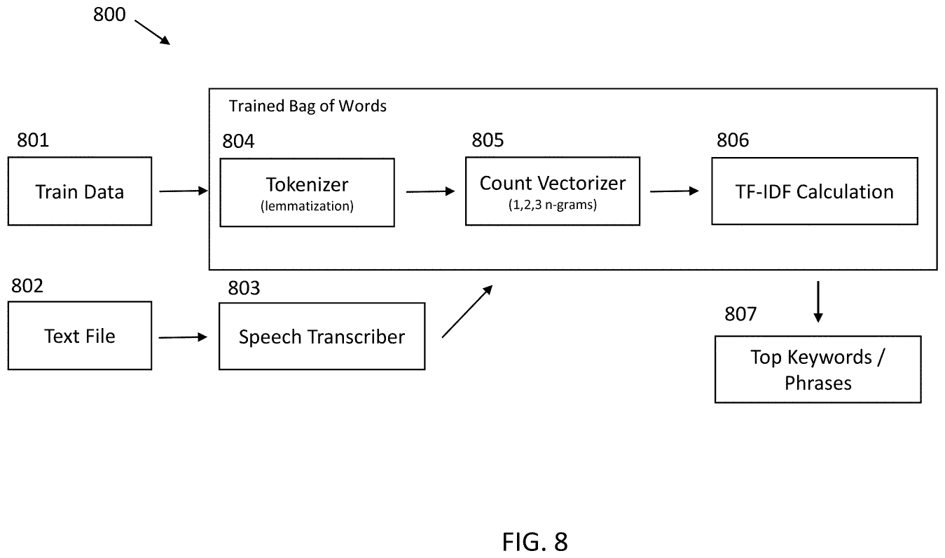

FIG. 8 is a flowchart illustrating training and deployment (800) of machine learning models of an embodiments of the system 120 for keyword detection in transcribed audio and/or user-entered text (e.g., entered via a GUI) in accordance with embodiments of the present disclosure (e.g., a keywords model). The trained keywords model can process recorded audio and transcribe it using a built-in library. The transcription of the audio and/or the user-entered text can be tokenized by individual words through the keywords model to gather common recurring words to gather the top discovered keywords.

The keywords model can use training data generated using training data including videos being analyzed (801). The training data can include multiple audio files from similar topics related to a specified category (e.g., leadership) to find reoccurring keywords amongst the conversations. Keywords that are not identified to be related to specified category which occur frequently are stored in a text file to safely ignore in the next training iteration. This training process can be iteratively performed until there is no longer any keywords that are unrelated to the topic of the provided audio training data. As a non-limiting example, the training data can include recorded TED Talks. The system 120 can use a speech transcriber to convert the audio components videos to text (802 and 803). The system 120 can preprocess the text by tokenizing the text to replace contractions with words (lemmatization), removing stop words (804) and creating a corpus of 1, 2, 3-gram sequences using count vectors (805). Count Vectorizer can be used by the system 120 to filter out words (e.g., “stop words”) found in the text. Stop words are keywords that are unrelated to the audio's topic that would prevent the keywords model from providing feedback related to the top keywords. The system 120 can calculate TF-IDF (806) of each sequence to find the top number relevant sequences which can be identified as keywords/key phrases (807). As a non-limiting example, the top five relevant sequences can be identified as keywords.

The final output of the top keywords derived from the keywords model can be further processed by the system 120 to describe the topic of the conversation to a user. This can be further improved by providing a summary of a video meeting/call which users can use to improve their personal notes from the meeting. This is done by changing the keywords model to provide top sentences that accurately describe the topic of a video meeting/call.

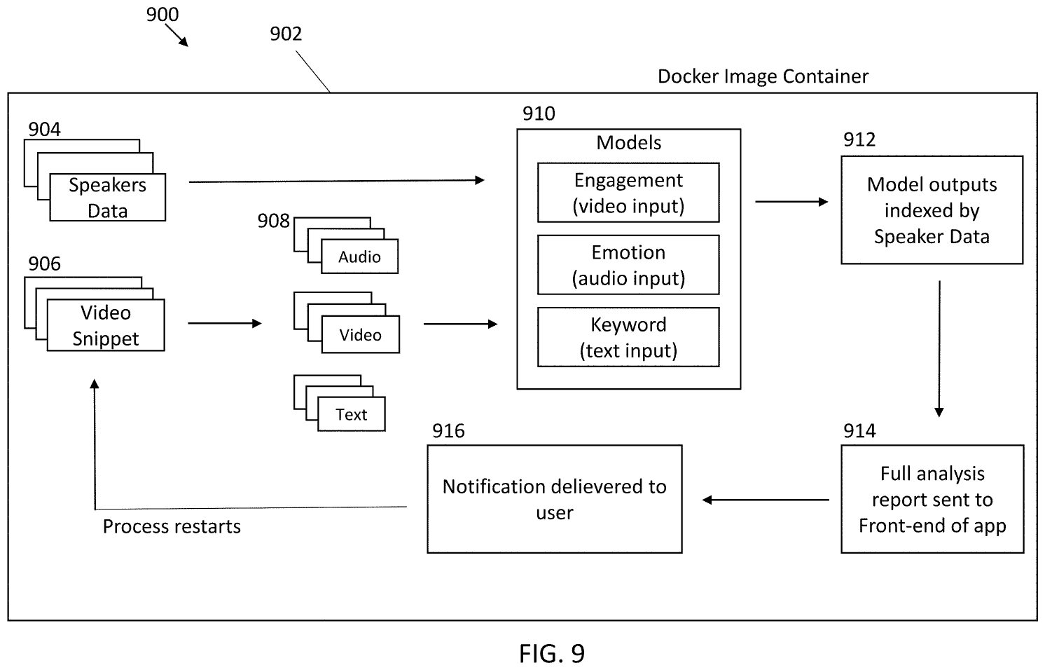

FIG. 9 is a flowchart illustrating training and deployment (900) of an ensemble of machine learning models to real-time feedback in accordance with embodiments of the present disclosure. The trained engagement model, emotion model, and keywords model can be dockerized and a docker image of the models can be built. This can be done through the dockerfile (a text file that has instructions to build image). Upon successful dockerization, the models can be running at all times. The docker image can be hosted by one or more servers (e.g., servers 114a), and the dockerized models can be called periodically at a set number of minutes to provide feedback to user.

The models of the system can be contained within a docker image container 902 and can be constantly running. At 904, the system 120 is receiving user/speaker data to provide indexed data depending on the context of the meeting. At 906, the system 120 is receiving video snippets (set number of minutes) from the meeting platform and processing the data into the various formats that the models require (Audio, Video, and Text components) - as show at 908. The data is run through the models at 910 and a report is generated indexed by the speaker data, illustrated in 912. The report can be sent to the front-end of the application at 914 and the system 120 can deliver a notification to a client device associated with a user which entails the report from the past set number of minutes at 916. The process is then repeated for the next interval of minutes.

### User Scenarios/Cases

One-on-one meetings, team standups, customer service calls, sales calls, interviews, brainstorming sessions, individual doing a presentation, group presentations, classroom settings and teacher/student dynamics, doctor/patient settings, therapist/client setting, call centers, any setting with individuals conversing with the intention to connect with each other.

| | Scenario | | Keyword | Engagement |
|---|---|---|---|---|
| | Summary | Emotion Analysis | Analysis | Analysis |
| Company | Interviewer asks | Interviewer | Interviewee | Interviewer |
| Interview | interviewee “Why | receives a | receives this | receives data on |
| | did you choose | categorization of | report that their | how |
| | our company?” | “stressed” that | top 5 keyword | engaged/enthusiastic |
| | Interviewer and | describes the | spoken while | interviewee is |
| | Interviewee are | emotion of the | answering this | while answering |
| | both users of the | interviewee while | question was | their question and |
| | application. | answering this | “excited.” They | uses that to assess |
| | | question. | implement a | interviewee. |
| | | | change where | |
| | | | they avoid using | |
| | | | the words | |
| | | | “excited” a lot. | |
| Medical | Doctor lets patient | Through the | Following the | Doctor sees that |
| Checkups | know the status of | patient's response, | meeting, | patient is not |
| | their lung tumor | doctor is able to | Interviewee sees | engaged during |
| | and patient reacts. | find out what | that Doctor has | the conversation - |
| | Doctor and patient | emotions the | said “prescription, | paired with the |
| | are both users of | patient is feeling, | calm, terminal, | emotion of stress. |
| | the application. | and converses with | concerning, | Doctor uses that |
| | | patient accordingly. | insurance.” This | information to |
| | | Patient is feeling a | re-enforces the | ensure patient is |
| | | multitude of | patients | listening to their |
| | | emotions, so model | understanding of | instructions/next |
| | | gives a breakdown | the meeting and | steps - and to |
| | | percentage of the | gives a mini- | keep morale high. |
| | | top 2 emotions - | recap. | |
| | | 50% “Surprised” | | |
| | | and 30% | | |
| | | “Stressed”. | | |
| Class | Teacher is | The teacher itself | Students see that | Teacher receives |
| Setting | explaining concept | can receive a | the teacher spoke | report that |
| | to students in a | categorization of | the words: | students are not |
| | lecture setting. | the emotion they | “derivative, | engaged. Using |
| | Teacher and | themselves are | optimization, | this information, |
| | students are all | projecting. During | chain, rule, | teacher asks |
| | users of the | her lecture, the | differentiation” | series of |
| | application. | teacher gets a report | which is directly | questions to |
| | | that she has been | related to the | students directly |
| | | majorly “Neutral.” | lecture topic in | interacting with |
| | | Using this piece of | math. This helps | them and |
| | | information, the | them ensure they | bumping up |
| | | teacher then bumps | took notes on the | engagement |
| | | up her enthusiasm | concepts that | levels. |
| | | level to excite her | were emphasized | |
| | | students in the | by the teacher. | |
| | | topic. | | |

Data can be collected over time to be able to train the models and deliver better feedback over time to individual users depending on context of the meeting as well. User demographic data (anonymized if possible) can be collect to discern industry trends and role trends within companies i.e. managers, senior managers etc. Specifically, baselines of individuals and group statistics can be useful in improving an accuracy or response of the feedback from the system. Industry averages, role trends, and geographical data can be utilized by the system to determine cultural differences.

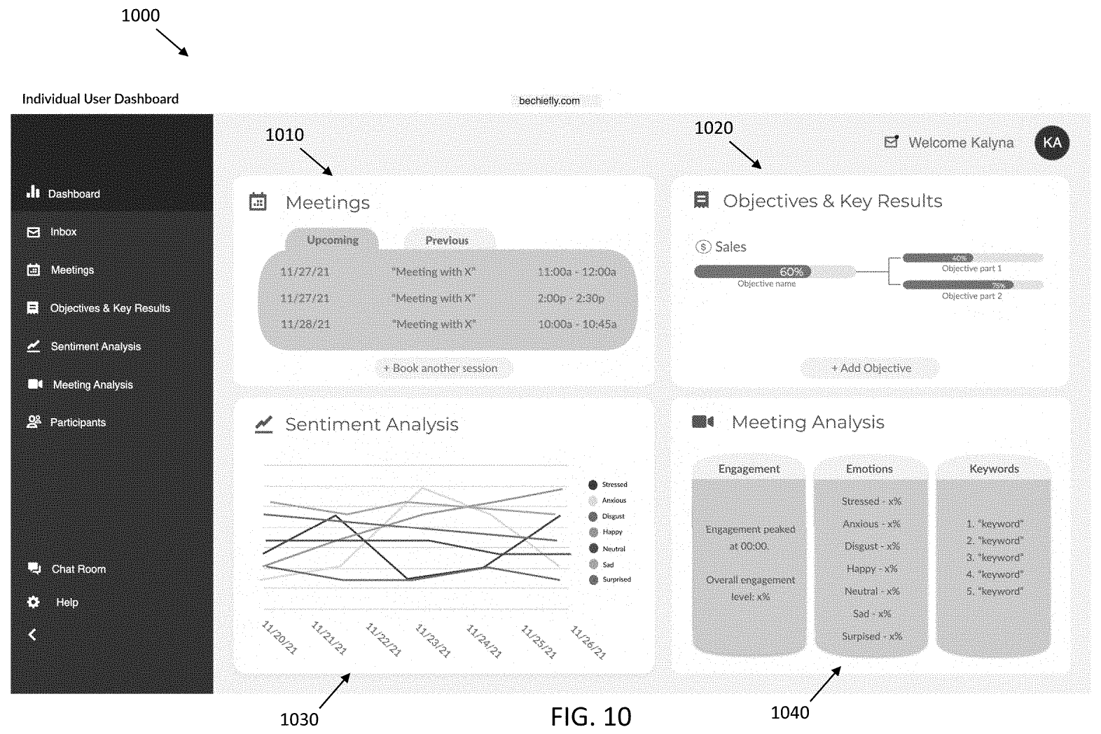

FIG. 10 illustrates a graphical user interface 1000 of an example embodiment of the system 100. The graphical user interface 1000 corresponds to a dashboard for a user and can include information and statistics associated with the user's interactions in video meetings or calls. As shown in FIG. 10, the dashboard can include a meetings section 1010, an objectives and key results section 1120, a sentiment analysis section 1030, and a meeting analysis section 1040. The meeting section 1010 can list upcoming video meetings or calls for the user and well as past video meetings or calls attended by the user. The objectives and key results section 1020 can identify objectives to be achieved during the meetings as well as the results of the meetings as they relate to the objectives. As a non-limiting example, an objective can be to generate sales and the key results can correspond to a percentage the meetings resulted in sales. The sentiment analysis section 1030 can identify sentiments of the user during the video meetings or calls based on the trained machine learning models. As a non-limiting example, the user's sentiments (e.g., stressed, anxious, disgust, happy, neutral, sad, and surprised) during the meetings can be depicted using a graph (e.g., a line graph) depicting the user's sentiments over time. The meeting analysis section 1040 can provide analysis of the user's performance during one or more meetings based on the output of the trained machine learning models. As a non-limiting example, the meeting analysis section 1040 can provide information to the user regarding the user's engagement (e.g., a level of overall engagement and a time at which the user's engagement peaked), emotions (e.g., a percentage of the time during the one or more meetings the user had one or more sentiments), and keywords (e.g., specific words that are identified as keywords spoken) during the one or more meetings.

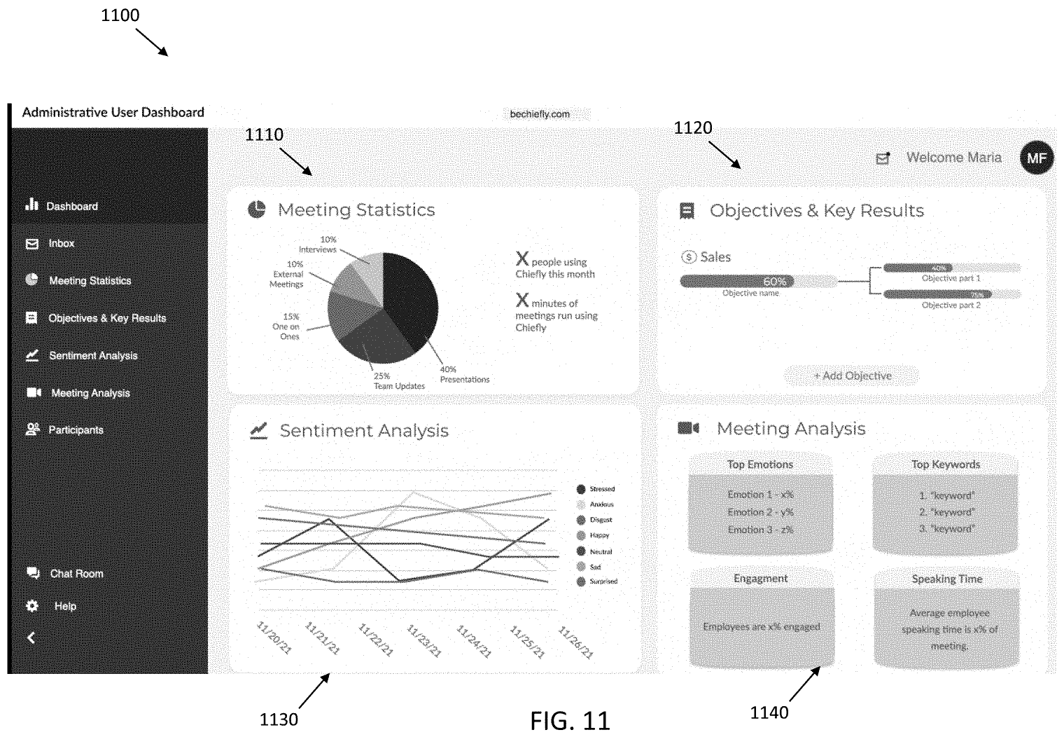

FIG. 11 illustrates a graphical user interface 1100 of an example embodiment of the system 100. The graphical user interface 1100 corresponds to a dashboard for an administrator of the system 100 and can include information and statistics associated with users interactions in video meetings or calls. As shown in FIG. 11, the dashboard can include a meetings statistics section 1110, an objectives and key results section 1120, a sentiment analysis section 1130, and a meeting analysis section 1140. The meeting statistics section 1110 can identify types of meetings for which the system 100 is being used, a quantity of individuals using the system 100 for their meetings, and/or a cumulative quantity of time that the system 100 has been used for meetings. The objectives and key results section 1120 can identify objectives to be achieved during the meetings held by the users of the system 100 as well as the results of the meetings as they relate to the objectives. As a non-limiting example, an objective can be to generate sales and the key results can correspond to a percentage the meetings resulted in sales. The sentiment analysis section 1130 can identify sentiments of the users of the system 100 during the video meetings or calls based on the trained machine learning models. As a non-limiting example, the users' sentiments (e.g., stressed, anxious, disgust, happy, neutral, sad, and surprised) during the meetings can be depicted using a graph (e.g., a line graph) depicting the users' sentiments over time. The meeting analysis section 1140 can provide analysis of the users' performance during one or more meetings based on the output of the trained machine learning models. As a non-limiting example, the meeting analysis section 1140 can provide information to the administrator regarding the users' emotions (e.g., top emotions), engagement (e.g., a percentage of engagement of the users), and keywords (e.g., top keywords), and speaking time (e.g., average time for which each user spoke) during the one or more meetings.

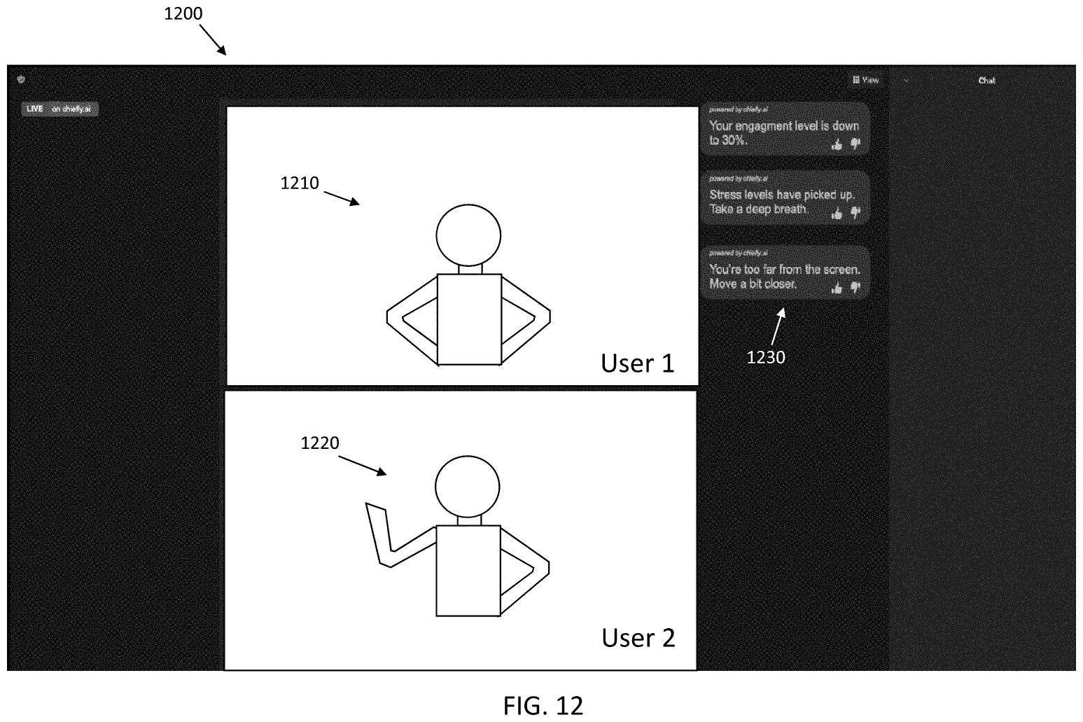

FIG. 12 illustrates an interaction between users 1210 and 1220 during a video meeting or call via a graphical user interface 1200 utilizing the system 100 in accordance with embodiments of the present disclosure. Video of the users 1210 and 1220 can be captured by their respective cameras, audio of the users 1210 and 1220 can be captured by their respective microphones, and user-entered text entered by the users 1210 and 1220 can be captured in a chat window. As described herein, video, audio, user-entered text from the meeting streamed or sent as a file can be processed by the system using one or more trained machine learning models to analyze body language, tone of voice, eye movements, hand gestures, speech and interaction frequency to understand key emotions (happiness, sadness, disgust, stress, anxiety, neutral, anger), engagement, motivation, and/or positivity toward an idea/willingness to adopt an idea of the user 1210 and the user 1220. The system 100 can provide feedback 1230 to the user 1210 and/or the user 1220 during the meeting based on the output of the trained machine learning models. As a non-limiting example, as shown in FIG. 12, the system 100 can render the feedback 1230 in the graphical user interface 1200 which can correspond to the graphical user interface rendered on the display of the client device being viewed by user 1210 (e.g., the feedback is not visible on the display of the client device being viewed by the user 1220). Non-limiting examples of the feedback 1230 that can be dynamically rendered in the graphical user interface 1200 can include a change in engagement level, a changes in one or more sentiments or emotions, a recommendation to improve a performance of the user 1210 during the meeting (e.g., move closer to the camera/display screen, speak more, take a break, etc.). The feedback can include options 1232 and 1234 that can be selected by the user 1210 to provide feedback to the system 100 (e.g., regarding an accuracy or helpfulness of the feedback 1230) and the system 1230 can use the user's feedback to improve/re-train the machine learning models. An example, the user 1210 can select the option 1232 (corresponding to a thumbs-down) if the user disagrees with or does not find the feedback 1230 to be accurate or helpful and can selection the option 1234 (corresponding to a thumbs-down) if the user agrees with or finds the feedback 1230 to be accurate or helpful. The feedback 1230 can be dynamically displayed on the screen to be positioned next to the video of the user to which the system 100 is providing the feedback 1230.

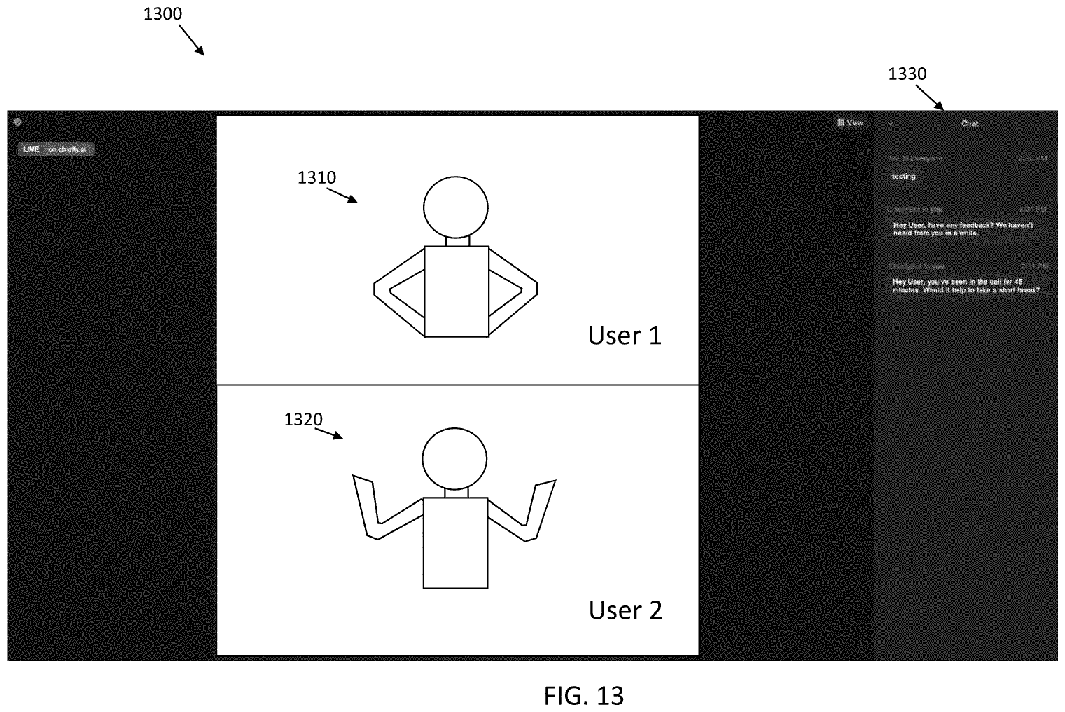

FIG. 13 illustrates an interaction between users 1310 and 1320 during a video meeting or call via a graphical user interface 1300 utilizing the system 100 in accordance with embodiments of the present disclosure. Video of the users 1310 and 1320 can be captured by their respective cameras, audio of the users 1310 and 1320 can be captured by their respective microphones, and user-entered text can be captured in a chat window. As described herein, video, audio, and/or user-entered text entered by the users 1310 and 1320 from the meeting streamed or sent as a file can be processed by the system using one or more trained machine learning models to analyze body language, tone of voice, eye movements, hand gestures, speech and interaction frequency to understand key emotions (happiness, sadness, disgust, stress, anxiety, neutral, anger), engagement, motivation, and/or positivity toward an idea/willingness to adopt an idea of the user 1310 and the user 1320. The system 100 can provide feedback 1330 to the user 1310 and/or the user 1320 during the meeting based on the output of the trained machine learning models. As a non-limiting example, as shown in FIG. 13, the system 100 can use a chat bot to provide the feedback 1330 in a chat area of the graphical user interface 1300. Non-limiting examples of the feedback 1330 that can be dynamically rendered in the graphical user interface 1300 can include a change in engagement level, a changes in one or more sentiments or emotions, a recommendation to improve a performance of the user 1310 and/or the user 1330 during the meeting (e.g., move closer to the camera/display screen, speak more, take a break, etc.). In some embodiments, the user 1310 and/or the user 1320 can provide feedback to the system by interacting with and/or responding to the chat bot and the feedback from the user 1310 and/or the user 1320 can be used by the system 100 to improve/re-train the machine learning models.

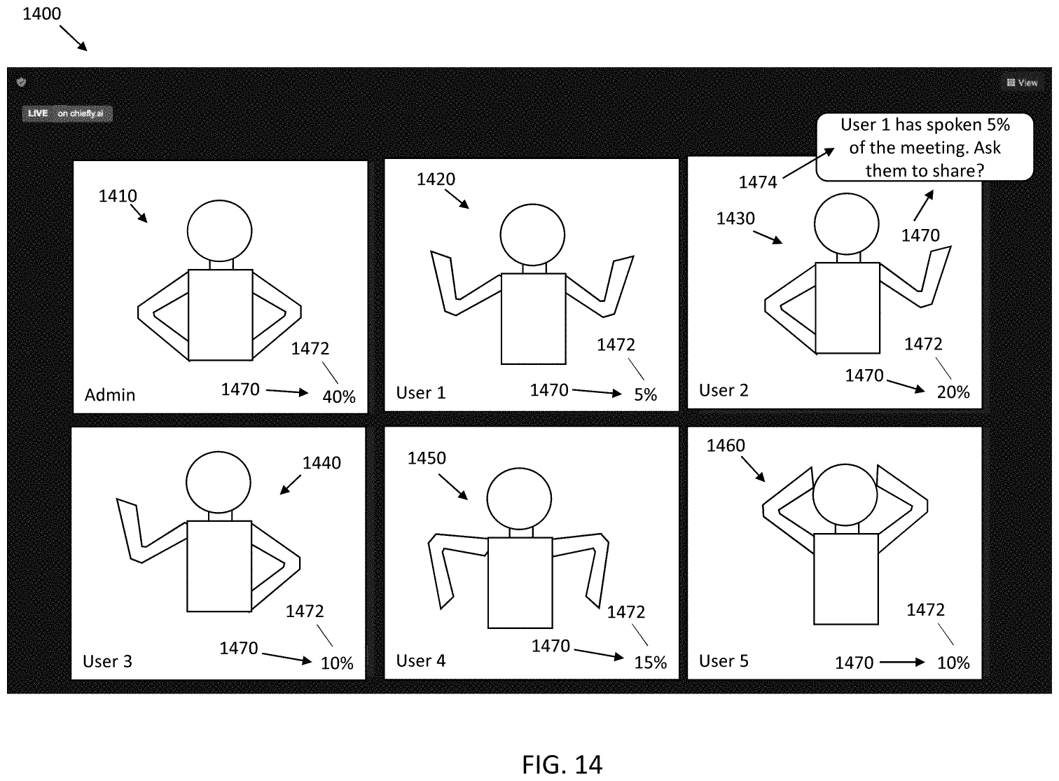

FIG. 14 illustrates an interaction between users 1410-1460 during a video meeting or call via a graphical user interface 1400 utilizing the system 100 in accordance with embodiments of the present disclosure. Video of the users 1410 and 1460 can be captured by their respective cameras, audio of the users 1410-1460 can be captured by their respective microphones. As described herein, video and audio from the meeting streamed or sent as a file can be processed by the system using one or more trained machine learning models to analyze body language, tone of voice, eye movements, hand gestures, speech and interaction frequency to understand key emotions (happiness, sadness, disgust, stress, anxiety, neutral, anger), engagement, motivation, and/or positivity toward an idea/willingness to adopt an idea of the user 1410-1460. The system 100 can provide feedback 1470 to one or more of the users 1410-1460 during the meeting based on the output of the trained machine learning models. As a non-limiting example, as shown in FIG. 14, the system 100 can render the feedback 1470 in the graphical user interface 1400 which can correspond to the graphical user interface rendered on the display of the client device being viewed by user 1410—an administrator (e.g., the feedback 1470 may or may not be visible on the display of the client device being viewed by the user 1420-1460 and/or other feedback may be visible in the graphical user interfaces being viewed by the user 1420-1460 via their respective client devices). In the present example, the feedback 1470 can correspond to a level of engagement 1472 of the users 1410-1460 and can be superimposed over each users video area and/or the feedback 1470 can correspond to text 1472 that is inserted into the graphical user interface 1400 by the system 100.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

The foregoing description of the specific embodiments of the subject matter disclosed herein has been presented for purposes of illustration and description and is not intended to limit the scope of the subject matter set forth herein. It is fully contemplated that other various embodiments, modifications and applications will become apparent to those of ordinary skill in the art from the foregoing description and accompanying drawings. Thus, such other embodiments, modifications, and applications are intended to fall within the scope of the following appended claims. Further, those of ordinary skill in the art will appreciate that the embodiments, modifications, and applications that have been described herein are in the context of particular environment, and the subject matter set forth herein is not limited thereto, but can be beneficially applied in any number of other manners, environments and purposes. Accordingly, the claims set forth below should be construed in view of the full breadth and spirit of the novel features and techniques as disclosed herein.

1. A method comprising:
training a plurality of machine learning models for facial recognition and audio analysis;
receiving visual-audio data corresponding to a video meeting or call between users;
separating the visual-audio data into video data and audio data;
executing a first trained machine learning model of the plurality of trained machine learning models to implement facial recognition to determine body language and engagement of at least a first one of the users;
executing a second trained machine learning model of the plurality of trained machine learning models to implement audio analysis to determine context of the video meeting or call and emotions of at least the first one of the users; and
autonomously generating feedback based on one or more outputs of the first and second trained machine learning models, the feedback being rendered in a graphical user interface of at least one of the first one of the users or a second one of the users during the meeting.

2. A system comprising:
a non-transitory computer-readable model storing instructions; and
a processor programmed to execute the instructions to:
train a plurality of machine learning models for facial recognition and audio analysis;
receive visual-audio data corresponding to a video meeting or call between users;
separate the visual-audio data into video data and audio data;
execute a first trained machine learning model of the plurality of trained machine learning models to implement facial recognition to determine body language and engagement of at least a first one of the users;
execute a second trained machine learning model of the plurality of trained machine learning models to implement audio analysis to determine context of the video meeting or call and emotions of at least the first one of the users; and
autonomously generate feedback based on one or more outputs of the first and second trained machine learning models, the feedback being rendered in a graphical user interface of at least one of the first one of the users or a second one of the users during the meeting.

3. A non-transitory computer-readable medium comprising instruction that when executed by a processing device causes the processing device to:
train a plurality of machine learning models for facial recognition and audio analysis;
receive visual-audio data corresponding to a video meeting or call between users;
separate the visual-audio data into video data and audio data;
execute a first trained machine learning model of the plurality of trained machine learning models to implement facial recognition to determine body language and engagement of at least a first one of the users;
execute a second trained machine learning model of the plurality of trained machine learning models to implement audio analysis to determine context of the video meeting or call and emotions of at least the first one of the users; and
autonomously generate feedback based on one or more outputs of the first and second trained machine learning models, the feedback being rendered in a graphical user interface of at least one of the first one of the users or a second one of the users during the meeting.
